(19) United States
(12) Patent Application Publication
(10) Pub. No.: US 2011/0303110 A1
(43) Pub. Date: Dec. 15, 2011

(54) SLEEVE FOR FLEXO PRINTING

(75) Inventors: Reinhard Grassler, Bruehl (DE); Stefan Gelhaus, Koeln (DE)

(73) Assignee: Felix Boettcher GmbH & Co. KG, Koeln (DE)

(21) Appl. No.: 12/677,649

(22) PCT Filed: Sep. 12, 2008
(86) PCT No.: PCT/EP08/62119

§ 371 Date: Jul. 27, 2010

(30) Foreign Application Priority Data
Sep. 12, 2007 (EP) 07116254.9
Jan. 7, 2008 (EP) 08100141.4

(51) Int. Cl. B41F 27/12; B41C 3/00

(52) U.S. Cl. 101/382.1; 101/483; 101/401.1

(57) ABSTRACT

Use of a sleeve for flexographic printing, comprising:

a base sleeve;

an intermediate layer enlarging the printing length, provided on the base sleeve and having a thickness of from 2 to 20 mm;

a laser-engravable layer of a radiation-cured polymer; for enlarging the repeat.

The present invention relates to a sleeve for flexographic printing and processes for the preparation thereof.

Flexographic printing is a printing method that is extensively employed for printing on packaging means made of plastics, paper, paperboard or cardboard.

On the one hand, printing plates, which are clamped onto a printing cylinder or mounting sleeve, are employed. This technology has the disadvantage that a seam remains after mounting and interferes with the printing process.

There are also seamless printing formes, in which the printing forme is prepared on a roller without a seam. Usually, sleeves whose outer side represents the printing layer are employed for this purpose; this means that only the roller coats are replaced and shipped, not the cores.

Typical materials for the printing layer of the sleeves in flexographic printing consist of rubber or photopolymers.

The technology of photopolymer polymerization has found a wide range of application. In this method, an existing image is imaged onto the photopolymer surface of the roller or plate, whereby the photopolymer cures in the exposed regions. Unexposed regions are washed off. The printing forme is thus generated upon drying.

An alternative is direct laser engraving. The unnecessary regions of the printing forme are removed by using a laser, and the remaining and removed regions then yield the printing forme. This is possible with both rubber-coated sleeves and sleeves in which a layer of a photopolymer is applied and polymerized on a base sleeve. Direct laser engraving is advantageous, in particular, because the necessary information is generally already available in digital form today, and direct engraving can save the step via the analogous imaging system.

Due to the fact that the photopolymer is directly applied to the base sleeve, the circumference of the printing forme is predetermined within narrow ranges. In order to achieve an enlarged outer circumference (=printing length) for a given inner diameter, a very large amount of photopolymer would have to be applied, which is very cost-intensive on the one hand, and the curing of the photopolymer becomes more difficult as the thickness increases, on the other. For greater layer thickness, the printing forme can become mechanically unstable due to the low hardness, which has a disadvantageous effect on the printing result.

The circumference of the roller or of the sleeve determines the printing length printable with the roller, or the repeat, i.e., the length after which the printing pattern repeats itself.

It was the object of the present invention to provide a sleeve coated with a photopolymer at low cost even for a greater total wall thickness and accordingly greater printing circumferences/printing lengths for a constant inner diameter.

This object is achieved by the use of a sleeve for flexographic printing, comprising:

a base sleeve;

an intermediate layer enlarging the printing length, provided on the base sleeve and having a thickness of from 2 to 20 mm;

a laser-engravable layer of a radiation-cured polymer;

for enlarging the repeat or the printing length.

The sleeve according to the invention includes a circumference-enlarging intermediate layer on the base sleeve. This intermediate layer has a thickness of about from 2 to 20 mm, preferably from 2 to 15 mm.

In some embodiments, it is preferred that the thickness of the intermediate layer is >5 mm or >8 mm or >10 mm.

Due to this intermediate layer, the distance between the outer printing layer and the central axis is increased, so that the printing length is increased and larger patterns can be printed. This increases the repeat.

The outer layer is a radiation-cured polymer, especially a photopolymer as previously employed in the prior art for corresponding sleeves.

The body of the sleeve typically consists of a plastic material reinforced by glass fibers. However, plastic materials reinforced by carbon fibers, for example, or other sleeve materials employed in flexographic printing may also be used.

Natural or synthetic rubber, but also polyurethane, is particularly useful as the intermediate layer enlarging the printing length. It is important that the intermediate layer has some mechanical and geometric stability so that it can be employed as a component of the printing forme in flexographic printing. A hardness of the material of ≧60 Shore A, preferably ≧80 Shore A, has proven particularly suitable.

In one embodiment, a further compressible layer, for example, made of a porous polyurethane, may be provided between the intermediate layer enlarging the printing length and the laser-engravable layer.

Radiation-curable polymers that can be engraved by means of a laser are known to the skilled person, for example, from EP 1 710 093 A1 or EP 1 424 210 A1, in which further suitable materials are described.

The invention further relates to the use of the sleeve according to the invention which has a pattern produced by laser engraving.

The sleeves according to the invention can be prepared by a process comprising the following steps:

providing a base sleeve;

applying an intermediate layer enlarging the printing length;

optionally finishing the surface of the intermediate layer;

applying a radiation-curable polymer;

curing said radiation-curable polymer by means of radiation.

In a particularly preferred embodiment, the radiation-curable polymer includes polymers liquid at room temperature. The latter allow for a particularly advantageous application to the intermediate layer.

The intermediate layer enlarging the printing length may be produced in different ways. For example, if it consists of a natural or synthetic rubber, the partially finished sleeve must be vulcanized at first. This will usually be followed by a surface finishing of the intermediate layer before the radiation-curable polymer is applied.

If polyurethane is employed for the intermediate layer enlarging the printing length, it may also be applied directly to the base sleeve in principle. It is also possible to surround the base sleeve with an outer sleeve and to insert the polyurethane layer between the base sleeve and the outer sleeve, followed by removing the outer sleeve. The outer sleeve may also be retained and coated with the photopolymer.

The applied radiation-curable polymer is subsequently cured. In the case of a photopolymer, this is effected by exposure, for example, to ultraviolet light.

Surprisingly, it is found that although the cured polymer exhibits sufficient adhesion on the intermediate layer enlarging the printing length, the layer of the cured polymer can be removed relatively simply, for example, by scoring and tearing. The intermediate layer enlarging the printing length is exposed again thereby and can be coated with a radiation-curable polymer again, optionally after surface finishing. In this way, the inner base sleeve with the intermediate layer enlarging the printing length can be recycled repeatedly.

The invention also relates to the use of an intermediate layer enlarging the printing length having a thickness of from 2 to 20 mm in a sleeve comprising a base sleeve and a laser-engravable layer of a radiation-cured polymer for enlarging the repeat of the sleeve.

The invention further relates to a sleeve for flexographic printing, comprising:

a base sleeve;

an intermediate layer enlarging the printing length, provided on the base sleeve and having a thickness of >6 mm, preferably from 8 to 20 mm;

a laser-engravable layer of a radiation-cured polymer;

for enlarging the repeat of the sleeve, and to a sleeve for flexographic printing, comprising:

a base sleeve;

an intermediate layer enlarging the printing length, provided on the base sleeve and having a thickness of from 2 to 20 mm and a hardness of ≧80 Shore A;

a laser-engravable layer of a radiation-cured polymer;

for enlarging the repeat of the sleeve.

The invention also relates to the use of the sleeve according to the invention in a process for laser direct engraving, and to the use of a sleeve with a pattern applied thereto in flexographic printing.

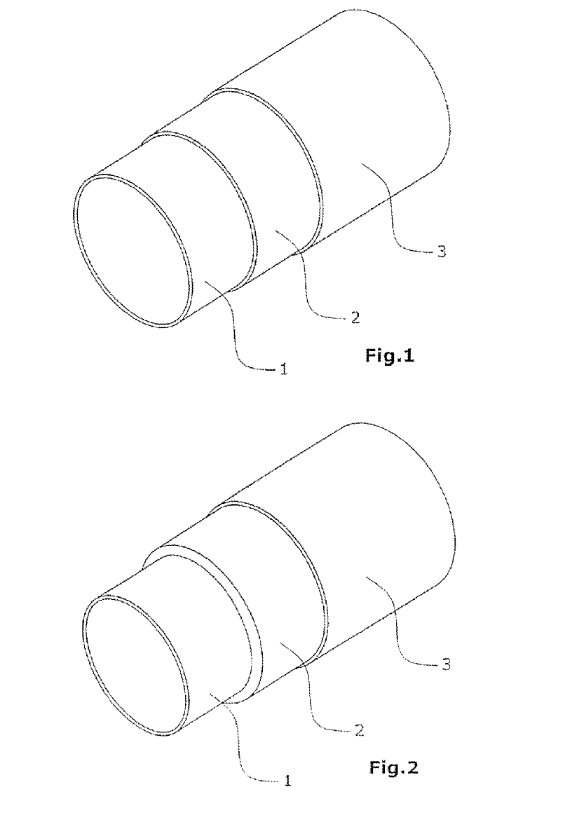

FIG. 1 schematically shows the structure according to the invention. On a base sleeve 1 made of a plastic material reinforced by glass fibers, there is provided an intermediate layer 2 enlarging the printing length, on which a layer of a cured photopolymer 3 is provided. The cured photopolymer can then be provided with a pattern for flexographic printing by laser engraving.

FIG. 2 shows a corresponding structure with a thicker intermediate layer 2.

### EXAMPLE

An appropriate application is provided in the present case, for example:

The printing machines is equipped with a take-up device for sleeves with an interior diameter of 136.989 mm. With the normal structure (base sleeve+coating=3.125 mm), a printing circumference of 450 mm could be achieved in this way.

However, if a pattern having a length of 480 mm is to be printed, an intermediate layer made of an intermediate rubber having a hardness of 80 Shore A is additionally inserted between the base sleeve and the functional layer according to the invention, so that a total sleeve thickness of 7.90 mm and thus an outer diameter of 152.79 mm is obtained. With this additional hard intermediate layer, a larger printing circumference is achieved at low cost, and at the same time the mechanical stability of the printing forme is retained.

1-12. (canceled)

13. A method for flexographic printing, comprising:
providing a sleeve comprising a base sleeve, an intermediate layer that enlarges a printing length of the sleeve, the intermediate layer being pro-vided on the base sleeve and having a thickness of from 2 to 20 mm, and a laser-engravable layer of a radiation-cured polymer, wherein a repeat of the sleeve is enlarged; and
using the sleeve for flexographic printing.

14. The method according to claim 13, wherein said base sleeve comprises a plastic material reinforced by glass fibers or of a plastic material reinforced by carbon fibers.

15. The method according to claim 13, wherein said intermediate layer is selected from synthetic rubber, natural rubber, polyurethane or mixtures thereof.

16. The method according to claim 13, wherein said radiation-cured polymer is a cured photopolymer.

17. The method according to claim 13, wherein a compressible layer is provided between the intermediate layer enlarging the printing length and the laser-engravable layer.

18. The method according to claim 13, wherein said laser-engravable layer has a pattern produced by laser engraving.

19. A method for enlarging a printing length of a sleeve in flexographic printing, comprising:
the sleeve comprising a base sleeve and a laser-engravable layer of a radiation-cured polymer
providing an intermediate layer having a thickness of from 2 to 20 mm between the base sleeve and the laser-engravable sleeve; and
using the sleeve for flexographic printing.

20. A sleeve for flexographic printing, comprising:
a base sleeve;
an intermediate layer that enlarges a printing length of the sleeve, the intermediate layer being provided on the base sleeve and having a thickness of at least 6 mm; and
a laser-engravable layer of a radiation-cured polymer;
wherein a repeat of the sleeve is enlarged.

21. A sleeve for flexographic printing, comprising:
a base sleeve;
an intermediate layer that enlarges a printing length of the sleeve, the intermediate layer being provided on the base sleeve and having a thickness of from 2 to 20 mm and a hardness of at least 80 Shore A; and
a laser-engravable layer of a radiation-cured polymer;
when a repeat of the sleeve is enlarged.

22. A process for preparing a sleeve according to claim 20 comprising:
providing a base sleeve;
applying an intermediate layer enlarging the printing length;
optionally finishing the surface of the intermediate layer;
applying a radiation-curable polymer;
curing said radiation-curable polymer by means of radiation.

23. A process for recycling a sleeve according to claim 20 comprising:
removing the radiation-cured polymer layer;
optionally finishing the surface of the exposed intermediate layer;
applying a radiation-curable polymer;
curing said radiation-curable polymer by means of radiation.

24. A method for flexographic printing, comprising:
providing a sleeve according to claim 20; and
using said sleeve for laser direct engraving.

25. A process for preparing a sleeve according to claim 21 comprising:
providing a base sleeve;
applying an intermediate layer enlarging the printing length;
optionally finishing the surface of the intermediate layer;
applying a radiation-curable polymer; and
curing said radiation-curable polymer by means of radiation.

26. A process for recycling a sleeve according to claim 21 comprising:
removing the radiation-cured polymer layer;
optionally finishing the surface of the exposed intermediate layer;
applying a radiation-curable polymer; and
curing said radiation-curable polymer by means of radiation.

27. A method for flexographic printing, comprising:
providing a sleeve according to claim 21; and
using said sleeve for laser direct engraving.
